(19) United States
(12) Patent Application Publication
(10) Pub. No.: US 2020/0388116 A1
(43) Pub. Date: Dec. 10, 2020

(54) INTERNET OF AUTOMATED TELLER MACHINE

(71) Applicant: HEWLETT PACKARD ENTERPRISE DEVELOPMENT LP, Houston, TX (US)

(72) Inventors: Basavaraj Mahalingappa Satanal, Bangalore (IN); Constants Amuthabalan Lourdusamy, Bangalore (IN)

(21) Appl. No.: 16/433,222

(22) Filed: Jun. 6, 2019

(51) Int. Cl. G07F 19/00; G06Q 20/10; G06Q 20/40

(52) U.S. Cl. CPC G07F 19/209; G06Q 20/1085; G07F 19/211; G07F 19/207; G06Q 20/407

(57) ABSTRACT

Systems and methods for responding to internet automated teller machine activity are provided. One method involves collecting cash parameters from a sensor in an automatic teller machine; collecting video images from a camera positioned about the automatic teller machine; generating a library of learned automatic teller machine parameters from the cash parameters and from the video images collected from the automatic teller machine over time; during the collecting the video images, detecting automatic teller machine events in the collected video images based on the library of learned automatic teller machine parameters; assigning response rules for responding to the detected automatic teller machine events; and sending the response rules to a host computer connected to the automatic teller machine and directing the host computer to take action according to the response rules.

### BACKGROUND

Automatic teller machines (ATMs) are unmanned devices used for performing automated bank transactions. Bank customers may visit an ATM to withdraw cash, deposit checks, check bank accounts, and perform other bank transactions. The ATM may be provided with cameras for recording images of the ATM and customers that visit the ATM. The ATM may be connected via a communication link to banks to receive banking information, such as available balance, cash limits, etc., necessary for performing the bank transactions. The ATM may also send information about the customer and the bank transactions performed at the ATM to the bank.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is a schematic of selected portions of a computing system, according to one or more examples of the disclosure.

FIG. 2A is a schematic of the computing system depicting portions of an ATM, according to one or more examples of the disclosure.

FIG. 2B is another schematic of the computing system including a block diagram of other portions of the ATM, according to one or more examples of the disclosure.

FIG. 3 is a schematic showing architecture of the computing system, according to one or more examples of the disclosure.

FIG. 4 is another schematic of selected portions of the computing system, according to one or more examples of the disclosure.

FIG. 5A is a flow chart depicting a method for responding to ATM activity, according to one or more examples of the disclosure.

FIG. 5B is a flow chart depicting another method for responding to ATM activity, according to one or more examples of the disclosure.

FIG. 6A is a flow chart depicting cash denomination sensor flow, according to one or more examples of the disclosure.

FIG. 6B is a flow chart depicting video surveillance flow, according to one or more examples of the disclosure.

While examples described herein are susceptible to various modifications and alternative forms, the drawings illustrate specific examples herein described in detail by way of example. It should be understood, however, that the description herein of specific examples is not intended to be limiting to the particular forms disclosed, but on the contrary, the intention is to cover all modifications, equivalents, and alternatives falling within the spirit and scope of the examples described herein and the appended claims.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

ATMs provide a way for banks to extend their services at various locations and for extended hours for the convenience of their bank customers. ATMs are unmanned units that operate without the assistance of a human bank teller. In order to perform the bank transactions, the ATM must be in communication with the bank to verify customer identification, determine account balances, and to enable transactions for each individual customer. Some ATM's are leased line machines that are directly connected to the bank. Other ATM's are remote units that remotely connect to the bank via a communication link.

Each ATM is typically connected to the bank via a host computer (processor). The host computer conveys information between the ATM and the bank to enable the bank transactions to be performed. For example, before an ATM can give cash to a bank customer, the host computer must query the bank to determine bank balances and withdrawal limits. Based on the bank information, the host computer may instruct the ATM to either decline or complete a withdrawal request from the bank customer. The host computer may also convey information about the bank customer to the bank for identification purposes, and to apply the withdrawal to the bank customer's account.

Some ATMs are provided with monitoring devices, such as cameras and sensors. images from the cameras and data from the sensors may be conveyed by the host computer to the bank. The bank may have bank personnel or third party contractors to view the images and the data to detect any irregularities. Upon detection of an irregularity, the bank may decide to take action to address the situation, for example, by calling police.

The present disclosure seeks to provide an automated system for capturing images and data collected at the ATM, and for sending real-time instructions to the host computer to respond to events detected from such images and data, in particular, the present disclosure employs an iATM platform to automatically capture the images and data from the ATM, and to build a library of historical data. This library may continuously receive images and data associated with ATM activity, and identify specific events within such data, such as machine malfunctions, security issues (e.g., theft), low cash levels in the ATM, etc. The library may also define response rules for addressing the detected events. Over time, the library may expand to learn from new data as it is received, and to update its understanding of events and the corresponding response rules.

Unlike the existing systems that employ manual monitoring and feedback, the disclosed computing system uses the collected images and data to respond to events as they occur, and to learn about conditions at the ATM over time. This stored understanding is used to define rules for taking action to address detected activity based on a comprehensive understanding of the ATM images and data. The iATM platform can also use the continuous data feeds in combination with the learned ATM data to anticipate conditions, and to notify the host computer and/or the bank to take pre-emptive action in advance of anticipated events. The library may be continuously updated to learn and to adjust to the needs of individual ATMs and/or groups of ATMs.

In some examples, a method is provided for responding to internet automated teller machine activity. One method involves collecting cash parameters from a sensor in an automatic teller machine; collecting video images from a camera positioned about the automatic teller machine; generating a library of learned automatic teller machine parameters from the cash parameters and from the video images collected from the automatic teller machine over time; during the collecting the video images, detecting automatic teller machine events in the collected video images based on the library of learned automatic teller machine parameters; assigning response rules for responding to the detected automatic teller machine events; and sending the response rules to a host computer connected to the automatic teller machine and directing the host computer to take action according to the response rules.

In some examples, a computer-readable, non-transitory storage medium is provided with instructions, that, when executed, causes the computing system to perform the method. In other examples, a computing system is provided for responding to internet automated teller machine activity. The computing system comprises a library, a computing resource, and a computer-readable, non-transitory storage medium with instructions executable by the computing system to perform the method.

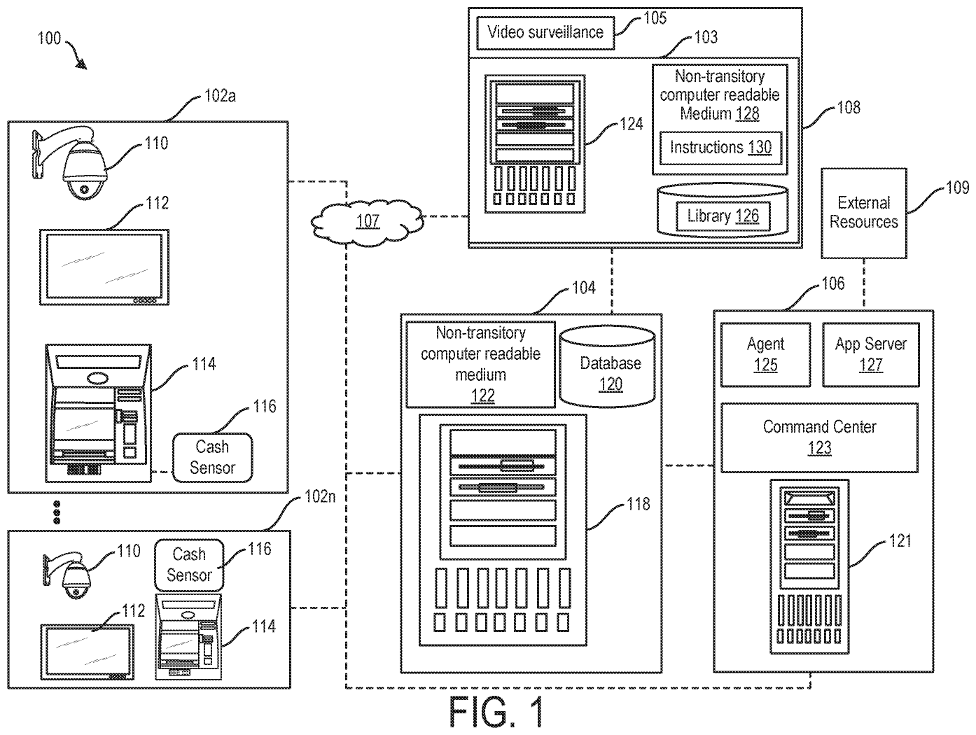

Turning now to the drawings, FIG. 1 is a schematic of selected portions of a computing system 100, according to one or more examples of the disclosure. The computing system 100, when invoked, performs ATM functions including methods for responding to automatic teller machine activity as is described further herein. The computing system 100 includes ATM business centers 102a-102n, host computer 104, a bank system 106, and iATM platform 108.

The iATM platform 108 is coupled by a network 107 to the ATM business centers 102a-102n and the host computer 104. The ATM business centers 102a-102n and the bank system 106 are also coupled by the network 107 to the host computer 104. The bank system 106 is coupled by the network 107 to external resources 109. The bank system 106 may also optionally be connected by the network 107 directly to one or more of the ATM business centers 102a-102n. Connections between the various components of FIG. 1 are depicted by dashed lines. These connections may be wired, wireless, onsite, offsite, remote, etc. The network 107 may employ an internet service provider to facilitate communication between the ATM business centers 102a-102n, the host computer 104, the bank system 106, and/or the iATM platform 108.

The ATM business centers 102a-102n may be located at various locations near or far from a bank. The ATM business centers 102a-102n may be in an enclosed room or at an open kiosk. Each of the ATM business centers 102a-102n includes an ATM 114 and a camera 110. The ATM 114 is an automated, unmanned machine usable by bank customers for performing bank transactions, such as making deposits, withdrawing cash, checking an account balance, transferring funds, etc. The ATM 114 may be a leased line ATM that connects directly to the host computer 104, or a remote ATM that connects to the host computer 104 through an internet or other connection.

Each of the ATMs 114 has a display board 112 and a sensor 116. The display board 112 displays information, such as cash denominations, available currency dashboard, bank policies, bank advertisements, etc. The display board 112 may be accessible by the host computer 104, bank system 106, and/or the iATM platform 108 for viewing information about the ATM 114. The sensor 116 may be positioned about the ATM 114 for measuring operating parameters of the ATM 114, such as printer jams, bank card insertion/removal, facility temperature, damage to the ATM 114, and cash levels. The sensor 116 may also be used to collect facility information concerning the ATM business centers 102a-102n, such as transaction dates/times, ATM location, affiliated bank, cash amounts, security systems, customer lists, bank transaction information, environmental conditions, etc.

In an example, the sensor 116 may be a cassette (cash) sensor positioned in a cash drawer of the ATM 114 to sense cash therein. The cassette sensor 116 may be positioned in a cash drawer in the ATM 114 to detect quantities of cash in the cash drawer and/or quantities of cash released from the ATM 114. Examples of cassette sensors are described in U.S. Pat. Nos. 8,689,700, 8,052,044, 8,172,131, 8,887,995, and Korean Patent Application No. 20060132217, the entire contents of which are hereby incorporated by reference herein.

The camera 110 may include one or more cameras, including a camera positioned in the ATM 114 and/or near the ATM 114. The camera 110 may be a video camera capable of recording intermittent, continuous, and/or upon request images. The camera 110 may be positioned to take images of the ATM 114, customers using the ATM, and/or people or things passing within a viewing area around the ATM 114. The camera 110 may have night vision, high definition or other capabilities to facilitate capture of images.

The ATM 114, the sensor 116, and/or the camera 110 may be coupled to remote devices, such as a computer, controller, or a processor, for operation thereof and/or for capturing data therefrom. For example, the sensor 116 may be coupled to a remote data collection device, such as a database for capturing sensor data measured by the sensor 116 as is described further herein. In another example, the camera 110 may be coupled to a video recorder for capturing the images taken by the camera 110. Data capture devices, such as the remote data collection device and the video recorder, may be positioned at the ATM 114, the host computer 104, the iATM platform 108, the bank system 106, and/or in other locations for capturing images and/or data as is described further herein.

The host computer 104, bank system 106, and the iATM platform 108 each include a computing resource 118, 121, and 124, respectively. These computing resources 118, 121, and 124 may include one or more servers, computers, and associated computing devices that reside on one or more computing apparatuses for performing the ATM operations as described further herein. The computing resources 118, 121, and 124 and/or other portions of the iATM platform 108 each include a variety of storage media (e.g., computer-readable, non-transitory storage medium). Such media may be any available media that is accessible by the computing system 100 and/or the computing resources 118, 121, and 124 for performing computer functions for the computing system 100.

As used herein, “computer-readable, non-transitory storage medium”, “non-transitory computer readable medium” or “machine-readable storage medium” may include a storage drive (e.g., a hard drive), flash memory, Random Access Memory (RAM), any type of storage disc (e.g., a Compact Disc Read Only Memory (CD-ROM), any other type of compact disc, a DVD, etc.) and the like, or a combination thereof. In some examples, a storage medium may correspond to memory including a main memory, such as RAM, where software may reside during runtime, and a secondary memory. The secondary memory can, for example, include a nonvolatile memory where a copy of software or other data is stored.

Each of the computing resources 118, 121, and 124 may perform ATM functions associated with the ATM business centers 102a-102n and related business transactions. Referring first to the host computer 104, the host computer 104 includes the computing resource 118, a database 120, and a non-transitory computer readable medium 122. The computing resource 118 may be coupled to the ATM business centers 102a-102n for operation therewith. The host computer 104 may act like an internet service provider or gateway for connecting the bank system 106 to various ATMs 114 for use by the bank customers.

In particular, the computing resource 118 of the host computer 104 may be coupled to the ATM 114 to pass information to and receive information therefrom. The computing resource 118 may also be coupled to the camera 110 to receive video images therefrom. Information received by the computing resource 118 from the ATM 114 and/or camera 110 may be stored in the database 120.

The host computer computing resource 118 may be operated based on instructions defined by the non-transitory computer readable medium 122. For example, the host computer 104 may interact with the ATM 114 to perform ATM functions, such as providing updated balance information to the ATM 114 for access by the bank customer, verifying customer passcodes, setting cash limits on customer withdrawals, etc. In another example, the host computer 104 may gather information from the ATM 114, such as receiving deposit and withdrawal information. In some cases, the computer resource 118 may receive requests from the ATM 114 for approval to proceed with a transaction. The computer resource 118 may communicate with the bank system 106 to obtain such approval. Upon receipt of the requested approval, the computer resource 118 may send authorization (or a code) to the ATM 114 to complete the transaction.

The bank system 106 is in communication with the ATM business centers 102a-102n via the host computer 104. The bank system 106 includes the computer resource 121, a command center 123, one or more agent workstations 125, and an application server 127. The computer resource 121 of the bank system 106 may be coupled to the computer resource 118 of the host computer 104 to exchange information concerning the ATM business center 102a-102n and/or business transactions performed thereby. During operation, the computing resource 118 of the host computer 104 relays requests from the ATM 114 to the bank system 106. For example, if cash is requested by a bank customer at the ATM 114 and sufficient funds are present, the bank system 106 withdraws the requested amount from the bank customer's account at the bank system 106, and sends approval to the ATM 114 via the host computer 104 to release the funds.

The bank system 106 uses the command center 123 to relay information to bank decision makers, such as agent workstation 125. The computer resource 121 and application server 127 may be used by the bank system 106 to manage bank information. For example, the computer resource 121 may be used to respond to queries from the host computer 104 for cash withdrawals. The agent workstation 125 may manually or automatically determine cash amounts in the bank customer's account and convey instructions via the command center 123 to the host computer 104 to provide cash to the bank customer based on such account information.

The computer resource 121 may be used to perform various bank functions, such as verifying bank customer information (e.g., customer identification, account limits, account balance, etc.). The computer resource 121 may include applications that detect bank cards and correlate pin numbers for customer identification. Specific applications may also be defined for performing various ATM operations, such as completing the bank transactions. The computer resource 121 may activate such applications upon direction from the command center 123.

The command center 123 receives incidents and customer experience, and sends data and commands to the agent workstations 125. Agents at the agent workstations 125, then log onto the command center 123 to open events, check severity of the events, and take action. One or more agents may scan the open events, and take action on such events. Each agent may select an event to monitor and complete. Once completed, the agent may select the next event. Each agent may take one event at a time, with each agent taking the next open event. Action taken for the events may include calling the external resources 109.

The application server 127 maintains the external resources 109, and provides real time data and relevant business logics. The application server 127 also supports the storage and playback of video clips, and reviews snapshots of relevant event alerts.

Information provided by the host computer 104 to the bank system 106 may generate alerts in the bank system 106. The host computer 104 may notify the bank system 106 of an event. Upon detection of the event, the bank command center 123 may notify its agent workstation 125 to respond to the event. The agent may then contact an appropriate external resource 109, such as cash delivery, police, ambulance, fire, or other service, as needed to address the event. For example, upon an alert from the host computer 104 of an empty ATM 114, the bank system 106 may contact the external resources 109 to send a cash delivery service to fill the ATM 114.

The iATM platform 108 is used to respond to activity at the ATM business centers 102a-102n, and to communicate with the host computer 104 concerning detected ATM activity. The iATM platform 108 includes a core server 103, and a video surveillance 105. The core server 103 includes the computer resource 124, a library 126, and a non-transitory computer readable medium 128. The iATM platform 108 is used to collect information from the ATM business centers 102a-102n and to detect activity from such information. Like the host computer, the computer resource 124 receives data from the sensor 116 at each of the ATMs 114 and video images from each of the cameras 110 of the ATM business center 102a-102n.

The data and images collected from the ATM 114 by the computer resource 124 may be stored in the library 126. The instructions 130 may enable the iATM platform 108 to receive and process the data and images received from the ATM business centers 102a-n, to identify events associated with such images and data, and to define response rules for addressing such events. The data and images collected by the iATM platform 108 may be correlated to assign date, time, and other identifiers to the images collected from the camera 110. The images may be processed for image enhancement and identification. As shown in FIG. 1, the video surveillance 105 may be a separate unit from the core server 103 that is used to capture and record the images as is described further herein.

The computer resource 124 may also be provided with capabilities for detecting certain events from activities seen in the images. For example, the images may show activities seen by the camera 110, such as customers in line at the ATM 114, customers entering bank cards into the ATM 114, persons passing by the ATM, etc. The computer resource 124 may examine the activity and then detect events that occur in such activity, such emergencies, equipment failures, security threats, etc.

The non-transitory computer readable medium 128 may also be used to ‘learn’ from the information collected from one or more of the ATMs 114 and/or the ATM business centers 102a-102n over time. The instructions 130 may include code that can detect patterns in the activity detected in the information collected over time from each of the ATM business centers 102a-102n. Such detection may be based on a comparison with past events recorded in the library 126. The collected images may be categorized according to classifications for events in the library 126, and assigned response rules based on such classifications. For example, the library 126 may have data concerning the typical number of bank customers that frequent the ATM business centers 102a-102n and the quantity of cash removed. The non-transitory computer readable medium 128 may use this information to determine when the ATM 114 is likely to be low on cash. Based on the images provided, the computer resource 124 may determine that, the amount of cash needed to supply the number of customers present is insufficient. The computer resource 124 may then send a response rule to the host computer 104 to take action accordingly.

The iATM platform 108 sends information collected to the host computer 104. The iATM platform 108 may send collected and/or processed data concerning the activities, the detected events, and the response rules to the host computer 104. The response rules provide an automated, real-time instruction to the host computer 104 to alert the bank system 106 of detected events. The iATM platform 108 uses the existing communication link and process between the host computer 104 and the bank system 106 to provide a means of real time response to the detected events. The host computer 104 may communicate the information and response rules to the bank system 106 so the bank system 106 may make decisions and take appropriate action.

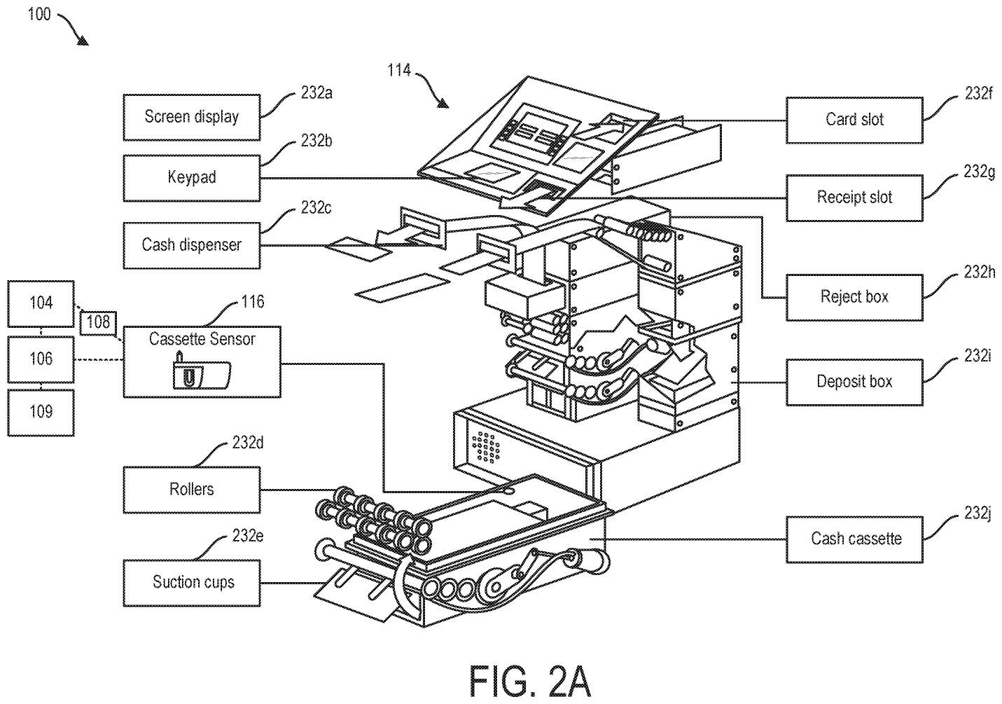

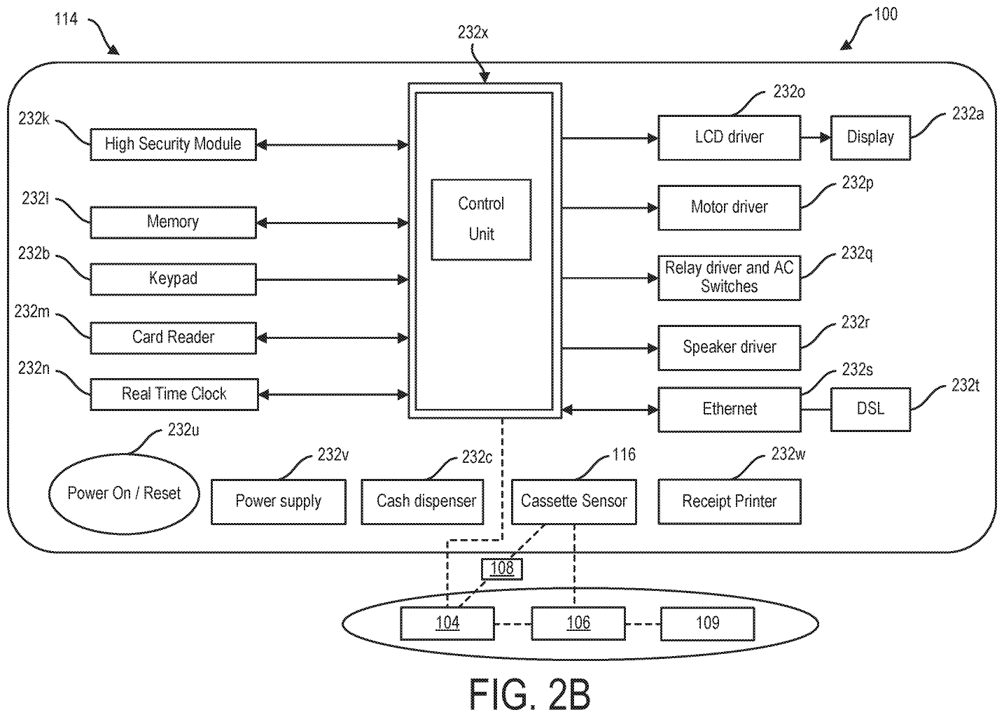

FIGS. 2A and 2B show features of the ATM 114 in greater detail. FIG. 2A is a schematic of the computing system 100 depicting portions of an ATM 114, according to one or more examples of the disclosure. As shown in this view, the ATM 114 is an ATM including various ATM components, such as a screen (customer) display 232a, keypad 232b, cash dispenser 232c, rollers 232d, suction cups 232e, card slot 232f, receipt slot 232g, reject box 232h, deposit box 232i, and cash cassette 232j. These components provide the mechanisms used in operating the ATM 114. The ATM 114 in this example is also provided with a cassette sensor 116 for measuring cash in the cash cassette 232j where money is stored in the ATM 114. The cassette sensor 116 may be able to detect quantities of cash denominations in the cash cassette 232j, as well as movement of cash into and out of the cash cassette 232j.

FIG. 2B is another schematic of the computing system including another view of the block diagram of the ATM 114, according to one or more examples of the disclosure. The ATM 114 in this figure is shown as including the keypad 232b, display 232a, cash dispenser 232c and cassette sensor 116 of FIG. 2A, but may also include the other features of FIG. 2A. As shown in FIG. 2B, the ATM 114 may also be provided with various other electronic components for performing the bank transactions, such as a high security module 232k, memory 2321, card reader 232m, real time clock 232n, liquid crystal display (LCD) driver 232o, motor driver 232p, relay driver and alternate current (AC) switches 232q, speaker driver 232r, ethernet 232s, digital subscriber line (DSL) 232t, power on/reset 232u, power supply 232v, receipt printer 232w, and control unit 232x.

As also shown in FIG. 2B, the control unit 232x may be in direct or indirect communication with one or more of the ATM components for operation thereof, such as the high security module 232k, memory 2321, card reader 232m, real time clock 232n, liquid crystal display (LCD) driver 232o, motor driver 232p, relay driver and alternate current (AC) switches 232q, speaker driver 232r, ethernet 232s, and digital subscriber line (DSL) 232t. The control unit 232x may have a processor in communication with the host computer 104 for operating the ATM components.

As also shown in FIGS. 2A and 2B, the cassette sensor 116 is communicatively coupled to the host computer 104, the bank system 106, and the iATM platform 108 for transmitting sensor data thereto. The bank system 106 is coupled to the external resources 109. Other sensors may optionally be provided for passing data to other portions of the computing system 100.

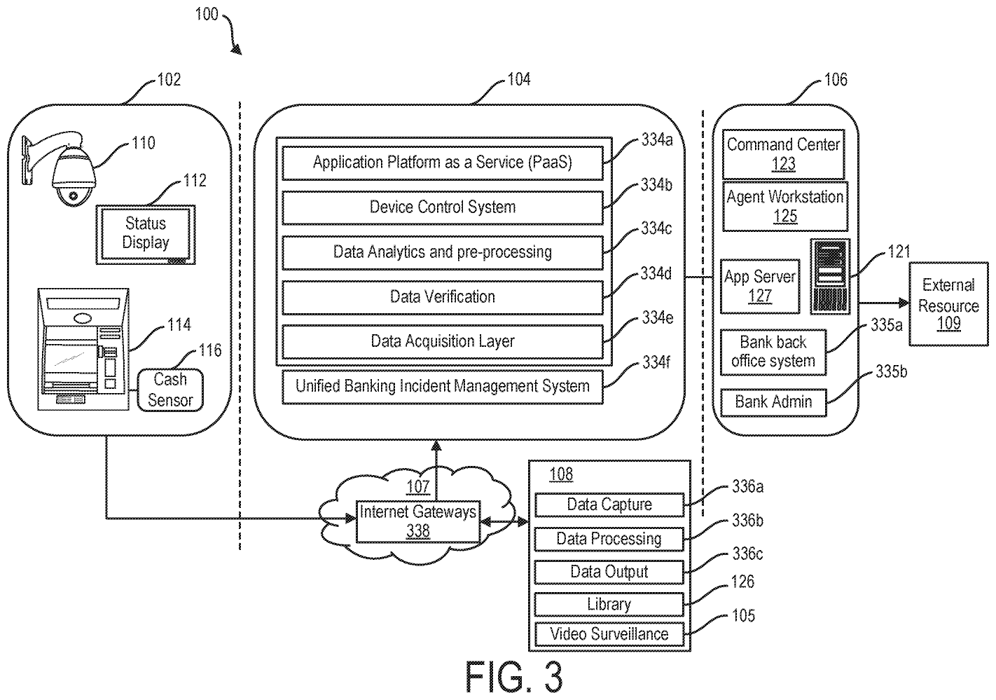

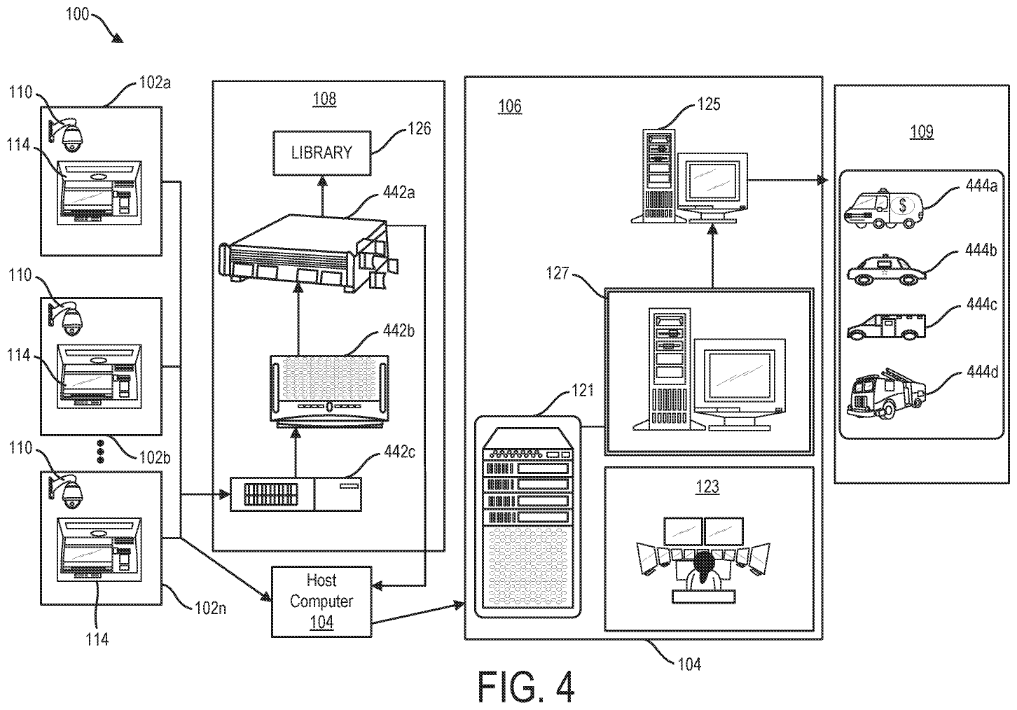

FIGS. 3 and 4 show various views of the computing system 100. Referring first to FIG. 3, a schematic architecture of the computing system 100 is shown, according to one or more examples of the disclosure. As shown in this view, the host computer 104 includes various components for operating the ATM business center 102 and for communicating with the bank system 106. The host computer 104 is communicatively connected to the ATM business center 102 and the bank system 106 via the network 107 using internet gateways 338. The iATM platform 108 is also in communication with the host computer 104 via the network 107 and the internet gateways 338. The internet gateways 338 may be security points that provide secure communication between components of the computer system 100. The internet gateways 338 may include one or more horizontally scaled, redundant devices, such as a Virtual Private Cloud (VPC), that allows communication between components via the internet. The VPC may be configured to provide low risk and unlimited bandwidth communications.

In this example, the host computer 104 includes various utilities for performing banking functions. Such utilities may include or be connected to software or hardware capable of communicating with the ATM 114 and the bank system 106. Such utilities may include an application platform as a service (PaaS) 334a, a device control system 334b, data analytics and pre-processing 334c, data verification 334d, data acquisition layer 334e, and unified banking incident management system 334f. The PaaS 334a may be used to provide a platform for cloud computing to develop, run, and manage applications in the host computer 104. The device control system 334b may be used to direct the host computer 104 to control devices, such as gateways and sensors associated with the computing system 100, in the host computer, and to facilitate bank customer authentication. The data analytics and pre-processing 334c may be used to gather data from the ATM 114 and transform the data into a format usable in the host computer 104 and the bank system 106. The data verification 334d may be used to check accuracy of data, and to detect any defective or inconsistent data. The data acquisition layer 334e may sample portions of collected data and convert the samples into digital values for use by the host computer.

As indicated by the box inside the host computer 104, the utilities 334a-334f may be housed together as a unit, with the unified banking incident management system 334 separate therefrom. The unified banking incident management system 334f may be used to monitor and detect security events at the ATM 114, and to execute action based on such events. Such execution may involve communicating the events and suggested responses to the bank system 106. The unified banking incident management system 334f may optionally be incorporated into the application server 127.

FIG. 3 also shows various utilities included in the iATM platform 108. In this example, the iATM platform 108 includes data capture 336a, data processing 336b, data output 336c, and the library 126. The data capture 336a may allow the iATM platform 108 to receive data from the cassette sensor 116 and images from the camera 110. Such data capture 336a may include storage for collecting the data and images from the ATM business center 102. The video surveillance 105 may also be provided to collect images captured by the camera 110. The video surveillance 105 may be included in the data capture 336a, or provided separately as shown. The video surveillance 105 may include a video recorder and associated devices for collecting and storing the images.

The data processing 336b may be used to collect, sort, filter, refine, and pre-process the data. The data processing 336b may, for example, correlate data, such as timestamps and customer identification, with the images. Data processing 336b may also be used to analyze the data and images. Such data processing 336b may be used to view activities at the ATM business center 102 and to detect events that occur in such activities. The detected events may be correlated to pre-assigned response rules. Data output 336c may be used to pass the data, images, activity, events, and response rules to the host computer 104. The data processing 336b and data output 336c may be connected to or incorporated within the library 126.

The iATM platform 108 collects the data, images, activity, events, response rules, and other information in the library 126. The library 126 may include or be coupled to databases and processors capable of building a history of ATM information. Such information may be classified and adapted over time to define an understanding of events that occur at the ATM business center 102. Event templates may be inserted, generated, expanded, modified or otherwise generated within the library 126. The event templates may be generated by detecting patterns in activities, such as average cash withdrawal rates, processing time per customer, security threats, emergencies, and machine malfunctions. The library 126 can learn from ongoing activity, detected events, user inputs, historical data, and other information to define scenarios that indicate an event has occurred. The library 126 can also define or import response rules corresponding to the event templates. The library 126 can use information specific to one ATM 114, or groups of ATMs 114. Some events may be specific to certain ATMs 114 or to certain ATM business centers 102. Some events may be pertinent to all or groups of ATMs 114.

While the library 126 may also use the video images and sensed data collected over time to define event templates for the events when they occur, the library 126 may also define pre-event templates that can detect activities that indicate an event may occur. As activity occurs and pre-event activity appears that is similar to activities that occur prior to a detectable event, the library may define response rules for taking action prior to the occurrence of the event. For example, as a given number of customers visit the ATM 114 and the sensor 116 detects cash levels, the iATM platform 108 can anticipate the number of transactions before a low or no cash situation arises. In such case, the response rule may be defined to schedule for the cash delivery at an appropriate time prior to the actual empty cash event.

The events may be defined, for example, as security, maintenance, emergency, operating, and other classifications. For example, the ATM 114 may send an error code indicating a stuck card or paper jam in the ATM 114. This error code may be classified as a machine malfunction event. A corresponding response rule, such as maintenance crew dispatch, may be assigned for machine malfunction events. In another example, images from the video camera may show ongoing bank customer traffic at the ATM 114 and the cash sensor 116 may sense cash levels in the ATM 114. The iATM platform 108 may detect a low cash event in the ATM 114 and send a response rule to dispatch cash services to the ATM 114. Other events, such as bank customer danger, machine attacks, power outages, etc., may also be detected and corresponding response rules defined. As new activities are detected, new event classifications may be made and corresponding response rules assigned. The library 126 can, therefore, learn from ongoing activity and other classifications to expand its knowledge base.

The host computer 104 is coupled to the bank system 106 for passing images and data received from the ATM business center 102 thereto. The host computer 104 may be programmed to act based on the guidelines defined within the host computer 104 and/or from the response rules provided by the iATM platform 108, The iATM platform 108 may be used to detect and analyze the data and images to detect events which define the response rules for the host computer 104. Using the learning capabilities of the non-transitory computer readable medium 128 (see, e.g., paragraph [0042]), images collected by the camera 110 at the ATM center 102 may be compared with images stored in the library 126. A comparison of the images collected on an ongoing basis may be performed to determine if certain events have occurred. The instructions 130 may include detection software capable of recognizing such events, Examples of conventional detection software that may be used include face, body posture, and other existing recognition software and/or logic

In this manner, the iATM platform 108 is capable of automatically and in real time defining response rules based on the learning provided in the library 126 (see, e.g., paragraphs [0042, 0053]). The library 126 collects new images on an ongoing basis and stores these new images in the library 126. As events are detected in the images, these images and associated events are categorized and stored in the library for future reference. These images associated with specific events may be added to the library 126 to further define features in the images which can be used for comparison with future images. This expands the existing library of images to include more and more additional images for comparison. As the library 126 grows to include more images, the capability of the iATM platform 108 to detect events also increases. Over time, such new images may increase the possible activities which identify events. Such images may also be used to refine the existing images to more clearly define the events that trigger alerts. The increase in images may further clarify the events of record in the library 126, thereby reducing the time needed to identify of the events. These response rules then enable the host computer 104 to automatically inform the bank system 106 of the detected events and recommended actions to be taken. The bank system 106 may then take appropriate action based on this information.

The host computer 104 may communicate collected information to the bank system 106. The host computer 104 may also communicate the detected events and the response rules received from the iATM platform 108 to the bank system 106. The bank system 106 may take action based on the information, the detected events, and/or the response rules. Such action may involve further processing the information and making decisions. In some cases, the command center 123 may distribute the information using the computer resource 121 to various agent workstations 125 for decision making or for taking action. The bank system 106 collects the received information, and selectively sends communications to the external resource 109. The communications from the bank system 106 may be communications based on a manual assessment of information received from the host computer 104 and/or communications based on the response rules sent from the iATM platform 108. The response rules may direct the host computer 104 to instruct the bank system 106 to contact the external resources 109. Other examples of response rules may include terminating a transaction, preventing a transaction, confiscating a customer bank card, sounding an alarm, communicating with persons near the automatic teller machine, etc.

The response rules may be automatically or manually assigned based historical events, such as low cash levels (see, e.g., paragraphs [0054-55]). In other examples, the library 126 transactions may be prevented if the bank customer's image does not match an image on file, an alarm may sound if a gun is detected in the images, or a message may be sent to the external resources if a call for help is made. The response rules in the library 126 may be defined to correspond to such existing activity, and may be triggered upon detection by the iATM platform 108. The computer resource 124 may then send a response rule to the host computer 104 to take action accordingly.

In addition to the computer resource 121, the command center 123, the agent workstation 125, and the application server 127 (as previously described), the bank system 106 is also shown as further including a bank back office system 335a and bank administration 335b. Some agent workstations 125 may be responsible for receiving events from the command center 123 and take action based on the events received. The bank back office systems 335a and bank administration 335b may be involved in communication and/or decision making for certain events, such as network outages across multiple ATM business centers or other global issues. Once action to be taken is determined, the agent workstations 125 may communicate with external resources 109 to implement the action required.

Referring now to FIG. 4, another schematic of selected portions of the computing system 100 is shown, according to one or more examples of the disclosure. This view shows additional details for the iATM platform 108, the bank system 106, and the external resources 109, This view also shows multiple ATM business centers 102a, 102b . . . 102n in communication with the iATM platform 108, the host computer 104, and the bank system 106.

As shown in this view, the iATM platform 108 may include hardware components configured to receive, store, and process the images and data. Such hardware components include a server 442a, a video recorder 442b, and a field switch 442c, The server 442a may be used in combination with or in place of the computer resource 124 of FIG. 1 for processing the data and images received from the ATM business centers 102a, 102b . . . 102n, identifying the events, and defining the response rules. The server 442a may be for example, an EDGELINE® server commercially available from HEWLETT PACKARD ENTERPRISE® out of Palo Alto, Calif. The server 442a may be in communication with the host computer 104 to pass the data, images, activity, events, and other information to the host computer 104. The video recorder 442b may be any recorder capable of receiving, storing, and communicating the video images from the cameras 110. The field switch 442c may be any switch capable of selectively permitting communication between the ATM business centers 102a, 102b . . . 102n and the video recorder 442b to permit image and/or data flow there through.

The bank components of the bank system 106 is shown as including the computing resource 121 coupled to the host computer 104 to receive the images, the data, the activity, the events, the response rules, and other communications from the host computer 104. The computing resource 121 is also coupled to the application server 127 to distribute this information received from the host computer 104 to corresponding servers for each bank associated with the ATM 114. The application server 127 may include one or more additional computer resources capable of receiving information from the host computer 104 and distributing the information to one or more agent workstations 125, The agent workstation 125 may then take action based the instructions received from the host computer 104. These instructions may include performing bank transactions for bank customers or taking action based on the response rules received from the iATM platform 108. For the response rules, the agent workstation 125 may contact one or more of the external resources 109 to address issues at the ATM centers 102a, 102b . . . 102n. As shown in FIG. 4, these external resources 109 may include cash delivery service 444a, police 444b, ambulance 444c, fire department 444d, or other action teams.

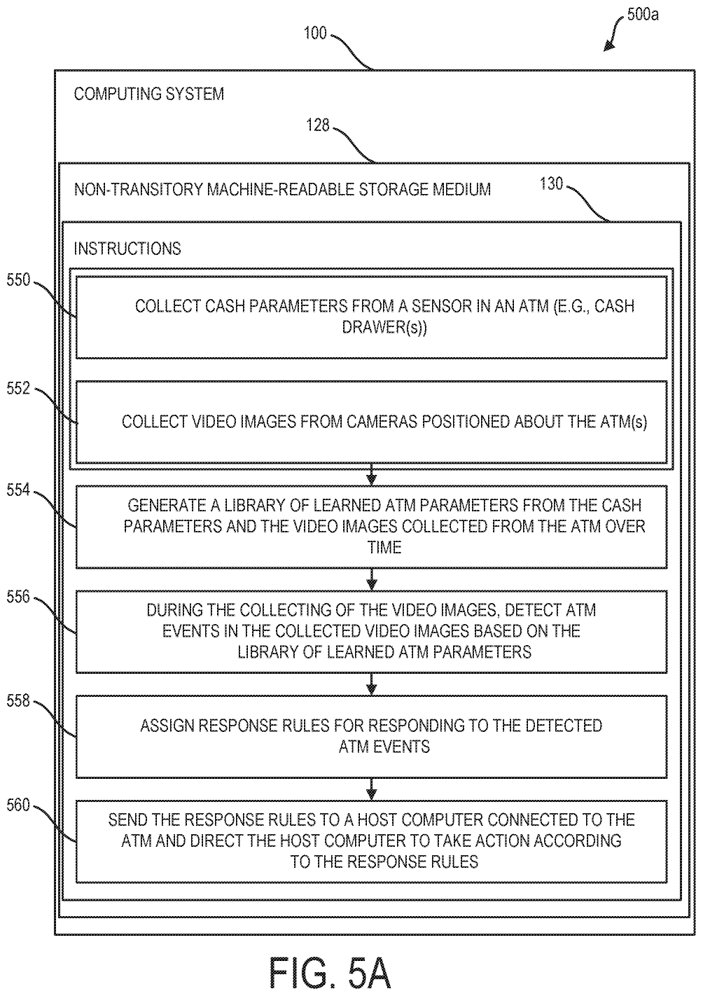

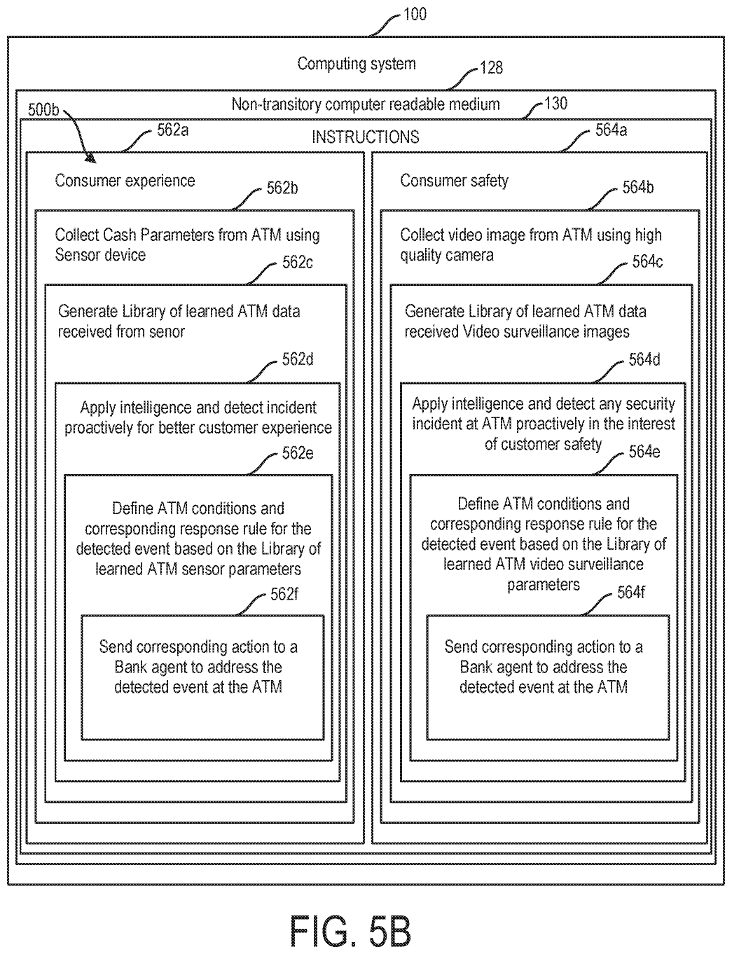

FIGS. 5A and 5B are flow charts depicting example methods that may be used in connection with the computer system 100. Referring to the first example method, FIG. 5A is a flow chart depicting a method 500a for responding to ATM activity, according to one or more examples of the disclosure. The method 500a may be implemented by a non-transitory machine-readable storage medium 128. The storage medium 128 comprises instructions 130, that, when executed cause a computing system 100 to perform the method 500a, In particular, the instructions 130 may cause the computing system 100 to: collect cash parameters from the sensor in an ATM (e.g., cash drawer(s)) (block 550); collect video images from a camera positioned about the ATM(s) (block 552); generate a library of learned ATM parameters from the cash parameters and from the video images collected from the ATM over time (block 554); during the collecting of the video images, detect ATM events in the collected video images based on the library of learned ATM parameters (block 556); assign response rules for responding to the detected ATM events (block 558); send the response rules to a host computer connected to the ATM and directing the host computer to take action according to the response rules (block 560).

Referring to the second example method, FIG. 5B is a flow chart depicting another method 500b for responding to ATM activity, according to one or more examples of the disclosure. As shown in this version, the computing system 100 uses the non-transitory computer readable medium 128 to perform a consumer experience 562a and consumer safety 564a. With the consumer experience 562a, the instructions 130 cause the computing system 100 to collect cash parameters from the ATM using a sensor device (e.g., cassette sensor 116 of FIG. 1) (block 562b); generate a library of learned ATM data received from the sensor (block 562c); apply intelligence and detect incidents proactively for a better customer experience (block 562d), define ATM events and corresponding response rules for the detected activity based on the library of learned ATM sensor parameters (block 562e); and send corresponding action to a bank agent (e.g., agent workstation 125) to address the detected event at the ATM (block 562f).

With the consumer safety 564a, the instructions cause the computing system 100 to collect video images from the ATM using a high quality camera (block 564b); generate a library of learned ATM data received from the video surveillance images (block 564c); apply intelligence and detect any security incident at the ATM proactively in the interest of customer safety (block 564d); define ATM conditions and corresponding response rules for the detected event based on the library of learned ATM video surveillance parameters (block 564e); and send corresponding action to a bank agent to address the detected activity at the ATM (block 564f).

The methods 500a, 500b may involve other operations, such as updating the library 126 (FIG. 1) of learned automatic teller machine parameters with the detected automatic teller machine events and defining event templates by detecting patterns in the video images and the cash parameters collected over time.

Part or all of the methods may be performed. The methods may be performed in any order and repeated as desired. As shown, for example, in FIG. 5A, blocks 550 and 552 may be performed simultaneously.

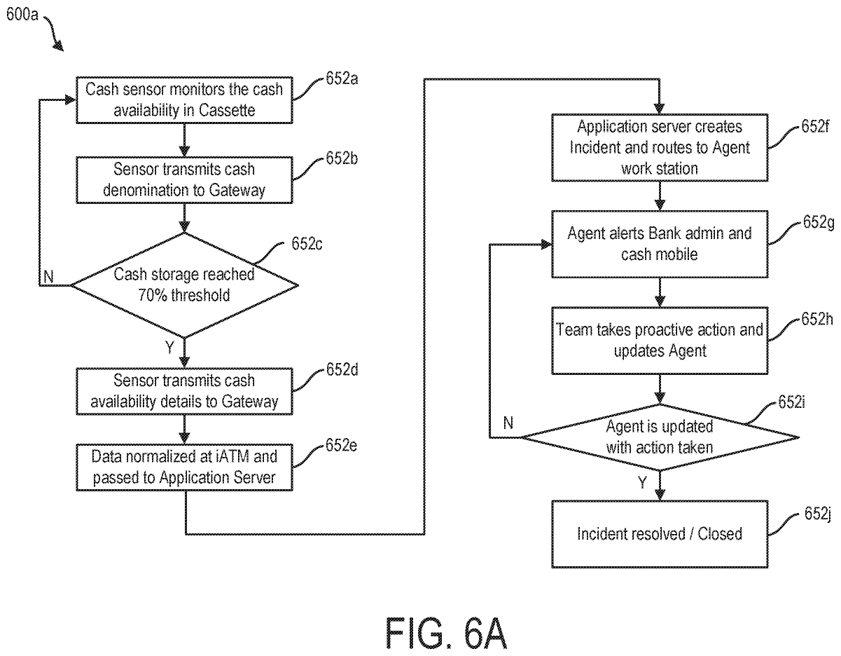

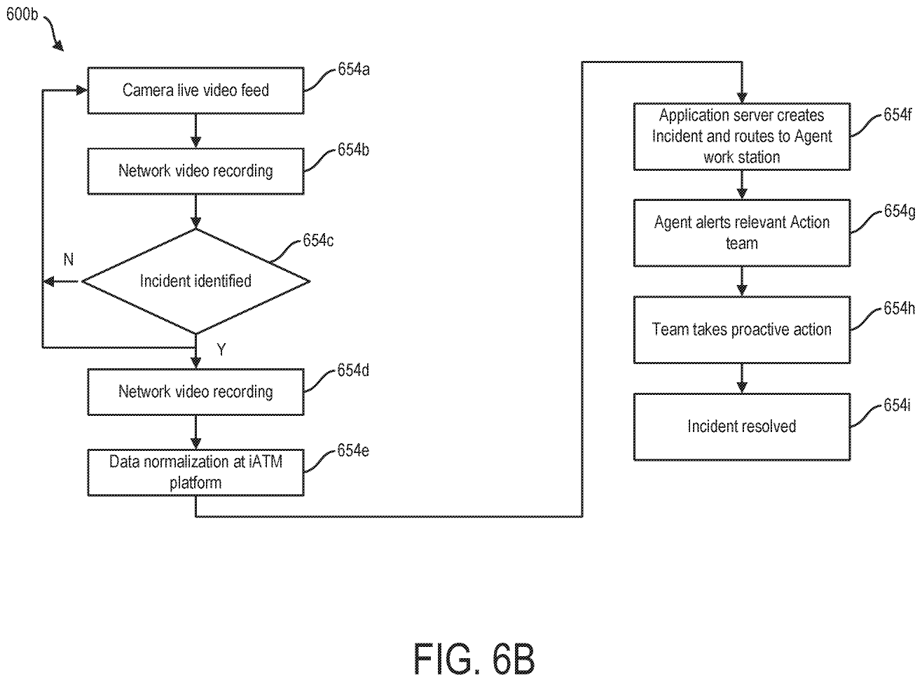

FIGS. 6A and 6B are flow charts depicting cash denomination sensor flow 600a and video surveillance flow 600b, respectively, according to one or more examples of the disclosure. The flow charts show example processes that may be performed using the devices and methods described herein. In particular, these flow charts 600a, 600b show example processes that may be used as the consumer experience 562a and the consumer safety 564a, respectively.

For the cash denomination sensor flow 600a of FIG. 6A, the cash sensor monitors the cash availability in the cassette (e.g., cassette sensor 116 and cash cassette 232j of FIG. 2A) (block 652a), and the sensor transmits sensor data, such as the cash denomination, to the gateway (e.g., 338 of FIG. 3) (block 652b). This data may then be sent to data capture 336a of the iATM platform 108, and added to the library 126. Blocks 662a and 652b may repeat until cash storage in the cash cassette 232j reaches a predetermined threshold, such as 70% (block 652c).

Once the threshold is reached, the sensor 116 may transmit cash availability details to the gateway 338 (FIG. 3) (block 652d), data may be normalized at the iATM platform 108 and passed to the application server 127 (FIG. 3) (block 652e), the application server 127 may create an incident and route the incident to the agent workstation 125 (block 652f), the agent at the agent workstation 125 may alert the bank administrator 335b to send the delivery service (cash mobile) 444a (FIG. 4) (block 662g), and a proactive approach may be taken with updates sent to the agent at the agent workstation 125 (block 652h). Blocks 652g and 652h may be repeated until the agent at the agent workstation 125 is updated with action taken (652i). once updated, the incident (event) may be resolved and closed (652j).

For the video surveillance flow 600b of FIG. 6B, the cameras 110 may send live video feed (block 654a) and a network video recording captured (block 654b). The video is monitored until an incident is identified in the video using the iATM platform 108 (block 654c). Once the incident is identified, network video recording is initiated (block 654d), data is normalized at the iATM platform 108 (block 654e), the application server 127 creates the incident and routes it to the agent workstation 125 (block 654f), the agent at the agent workstation 125 alerts the action team (e.g., external resources 109) (block 654g), the action team takes proactive action (block 654h), and the incident is resolved (block 654i).

As provided above, examples in the present disclosure may also be directed to a non-transitory computer-readable medium storing computer-executable instructions and executable by one or more processors of the computer via which the computer-readable medium is accessed. A computer-readable media may be any available media that may be accessed by a computer. By way of example, such computer-readable media may include random access memory (RAM), read-only memory (ROM), electrically erasable programmable read-only memory (EEPROM), compact disk read-only memory (CD-ROM) or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Note also that the software implemented aspects of the subject matter claimed below are usually encoded on some form of program storage medium or implemented over some type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

Furthermore, examples disclosed herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A method for responding to automatic teller machine activity, comprising:
collecting cash parameters from a sensor in an automatic teller machine;
collecting video images from a camera positioned about the automatic teller machine;
generating a library of learned automatic teller machine parameters from the cash parameters and from the video images collected from the automatic teller machine over time;
during the collecting of the video images, detecting automatic teller machine events in the collected video images based on the library of learned automatic teller machine parameters;
assigning response rules for responding to the detected automatic teller machine events; and
sending the response rules to a host computer connected to the automatic teller machine and directing the host computer to take action according to the response rules.

2. The method of claim 1, wherein the generating the library of the learned automatic teller machine parameters comprises correlating the collected cash parameters with the collected video images.

3. The method of claim 1, wherein the cash parameters comprise at least one of: time/date stamps, customer information, and facility information.

4. The method of claim 3, wherein the customer information comprises at least one of: customer identification, account limits, and account balance.

5. The method of claim 3, wherein the facility information comprises at least one of: location, bank, cash amounts, security systems customer lists, and environmental conditions.

6. The method of claim 1, further comprising defining event templates by detecting patterns in the video images and the cash parameters collected from the automatic teller machine over time.

7. The method of claim 6, wherein the patterns comprise at least one of: average cash withdrawal rates, processing time per customer, security threats, emergencies, and machine malfunctions.

8. The method of claim 6, wherein the assigning response rules comprises defining the response rules corresponding to the event templates.

9. The method of claim 8, wherein the response rules comprise alerting at least one of: a cash delivery service, a police department, an ambulance, and a fire department.

10. The method of claim 6, wherein the detecting automatic teller machine events comprises identifying the automatic teller machine activity that matches the event template.

11. The method of claim 10, wherein the detecting automatic teller machine events comprises anticipating the automatic teller machine events by identifying the automatic teller machine activity that occurs prior to the automatic teller machine events.

12. The method of claim 1, wherein the sending the response rules to the host computer comprises directing the host computer to send an alert to at least one of: a bank system and external resources.

13. The method of claim 1, wherein the response rules comprise instructions to terminate a transaction, prevent the transaction, confiscate a customer bank card, sound an alarm, or communicate with persons near the automatic teller machine.

14. The method of claim 1, further comprising updating the library of learned automatic teller machine parameters with the detected automatic teller machine events.

15. A computer-readable, non-transitory storage medium encoded with instructions that, when executed by a computing resource, cause the computing resource to:
collect cash parameters from a sensor in an automatic teller machine;
collect video images from a camera positioned about the automatic teller machine;
generate a library of learned automatic teller machine parameters from the cash parameters and from the video images collected from the automatic teller machine over time;
during the collecting the video images, detect automatic teller machine events in the collected video images based on the library of learned automatic teller machine parameters;
assign response rules for responding to the detected automatic teller machine events; and
send the response rules to a host computer connected to the automatic teller machine and direct the host computer to take action according to the response rules.

16. The computer-readable, non-transitory storage medium of claim 15, wherein the cash parameters and the video images are collected simultaneously.

17. A platform for responding to automatic teller machine activity, comprising:
a library coupled via a communication link to a sensor and a camera of an automatic teller machine to receive data therefrom; and
a computing resource coupled to the library, the sensor, and the camera;
a computer-readable storage medium comprising instructions executable by the computer resource to:
collect cash parameters from the sensor in the automatic teller machine;
collect video images from the camera positioned about the automatic teller machine;
generate in the library learned automatic teller machine parameters from the cash parameters and from the video images collected from the automatic teller machine over time;
during the collecting the video images, detect automatic teller machine events in the collected video images based on the learned automatic teller machine parameters;
assign response rules for responding to the detected automatic teller machine events; and
send the response rules to a host computer connected to the automatic teller machine and direct the host computer to take action according to the response rules.

18. The platform of claim 17, wherein the computing resource comprises one or more servers communicatively coupled to the host computer.

19. The platform of claim 17, wherein the computing resource comprises one or more servers communicatively coupled to a bank system via the host computer.

20. The platform of claim 17, further comprising a video recorder and a field switch coupled to the computer resource.
